(19) United States
(12) Patent Application Publication
(10) Pub. No.: US 2004/0105370 A1
(43) Pub. Date: Jun. 3, 2004

(54) METHOD FOR DISCRIMINATING OPTICAL MEDIA TYPE

(76) Inventors: Jen-Yu Hsu, Taipei City (TW); Hsiang-Yi Fu, Taipei City (TW); Tun-Chieh Lee, Taipei City (TW); Fu-Hsiang Chen, Taipei City (TW); Yao-Chou Tsai, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,715

(22) Filed: Aug. 12, 2003

(30) Foreign Application Priority Data
Nov. 29, 2002 (TW) 091134893

(51) Int. Cl. G11B 7/00

(52) U.S. Cl. 369/53.22

(57) ABSTRACT

A method for discriminating optical media type includes positioning a reading unit of the optical drive at a first position, moving the reading unit to a second position so that a light spot passes over a data layer of the optical media, continuing measuring the reflection of the laser beam to obtain a first time when the reflection is larger than a predetermined reflection, moving the reading unit back to the first position so that the light spot again passes over the data layer of the optical media, continuing measuring the reflection of the laser beam to obtain a second time when the reflection is larger than the predetermined reflection, and calculating the time difference between the second time and the first time and comparing with at least one predetermined time in order to discriminate the type of the optical media.

### BACKGROUND OF INVENTION

1. Field of the Invention

The present invention relates to a method for discriminating optical media type, and more specifically, to a method for distinguishing DVDs and CDs for optical disk drives.

2. Description of the Prior Art

Optical data storage media attracts the attention of the industry and consumers due to its large capacity and non-contact reading. From read-only LDs, CDs, and CD-ROMs to rewritable CD-RWs, restricted by the original physical structure, standards, and technology, a breakthrough in capacity was not realized until DVDs were introduced. DVDs, with shorter track spacing, shorter pit length, and utilizing light with shorter wavelength, have a capacity that is increased to over seven times conventional CD-ROMs.

The specifications of DVD are as follows:

1. Book A: DVD-ROM. DVD-ROM drives must be compatible with CD-ROMs.

2. Book B: DVD-Video. DVD-Video drives must be compatible with Video CDs.

3. Book C: DVD-Audio. DVD audio drives must be compatible with CDs.

4. Book D: DVD-R. DVD-R drives must be compatible with CD-RWs.

5. Book E: DVD-RAM using phase change optical disks.

In the above-mentioned specifications, since DVD players must be compatible with conventional CD-ROMs, Video CDs, CDs and CD-RWs. However, due to different physical structures and reading methods, a DVD drive should distinguish between DVDs and CDs rapidly in order to adopt the proper reading method.

Please refer to FIG. 1 showing a pickup head and other devices for reading a disk 20 in a conventional optical disk drive. The pickup head includes a laser diode 10 generating a laser beam with specific wavelength. The laser beam passes through a polarization spectroscope 11, and is then converged to parallel beams by a converging lens 12. A one-fourth wavelength plate 13 converts the parallel beams from linearly polarized beams into circularly polarized beams, and then the circularly polarized beams are focused by an object lens 14 as a light spot SP on the disk. The pickup head further includes a drive circuit 30 for driving an actuator 32 in order to control the object lens 14 to move along the light axis, and change the position of the light spot SP, so that the light spot SP can be focused on a data layer on the disk. The light spot SP is reflected by the data layer to form a beam. The beam passes through the object lens 14 and the one-fourth wavelength plate 13, through which it is converted from circular polarization to linear polarization, and then passes through the converging lens 12 to the polarization spectroscope 11. The linear polarizing direction of the reflected beam is perpendicular to the direction of the original one, so that the beam will be reflected to a focus lens 15 and received by a detector 16. Please refer to FIG. 2 and FIG. 3 showing a conventional method for discriminating optical disks. The distance between the data layer 22 and the transparent layer“s boundary is 0.6 mm in a DVD, while the distance between data layer 22 and the transparent layer“s boundary is 1.2 mm in a CD (the disk is 1.2 mm in thickness, in which the data layer is very close to a printed layer opposite to the transparent layer“s boundary). Therefore, disk types are distinguished by using the beam being reflected by the transparent layer“s boundary and data layers to measure the distance at different times. More specifically, as shown in FIG. 4, the transparent layer“s boundary causes a smaller reflection peak, and the data layer causes a larger reflection peak. For a DVD, the distance between the two reflection peaks is approximately 0.6 mm, and for a CD, the distance is approximately 1.2 mm. By discriminating the time difference or the distance difference, DVDs and CDs can be distinguished from one another. However, the transparent layer“s boundary causes only a small amount of reflection and, therefore, the position of the transparent layer reflection peak is not easily confirmed. This small reflection peak means that the distance between the data layer and the transparent layer“s boundary cannot be discriminated, which causes misjudgment.

### SUMMARY OF INVENTION

It is therefore a primary objective of the present invention to provide a method for discriminating optical media type in order to distinguish DVDs and CDs for optical disk drives.

Briefly summarized, a method for discriminating optical media according to the present invention includes moving a pickup head between two extreme positions so that the focused beam can pass through a data layer of a disk twice, and measuring time difference or distance difference between two reflection peaks over a determined value of reflection in order to distinguish the disk“s type. By not detecting the reflection peak of a transparent layer, misjudgment is reduced and the optical disk drive efficiency is increased.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a conventional optical disk device reading mechanism.

FIG. 2 and FIG. 3 illustrate a conventional method for discriminating optical disks.

FIG. 4 illustrates measuring reflection parameters according to the prior art.

FIG. 5 and FIG. 6 illustrate a move path of a light spot according to the present invention.

FIG. 7 illustrates measuring reflection parameters according to the present invention.

FIG. 8 illustrates a procedure for discriminating optical media type according to the present invention.

### DETAILED DESCRIPTION

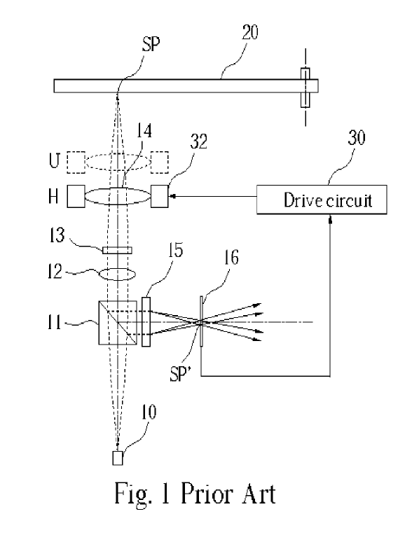

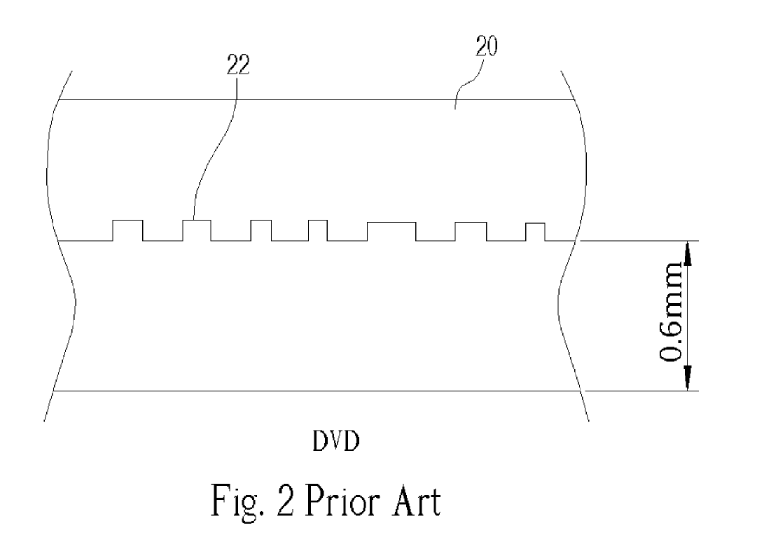

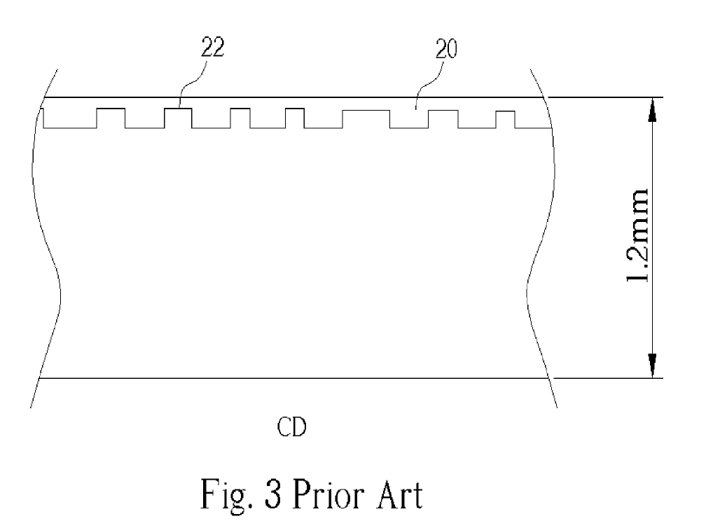

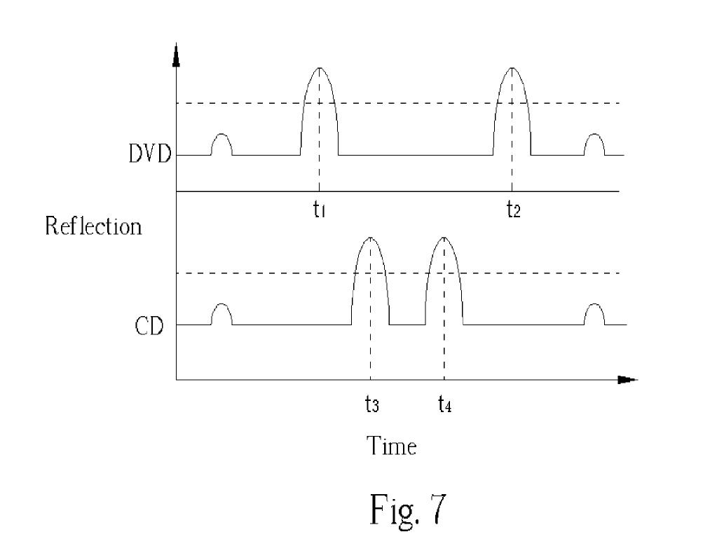

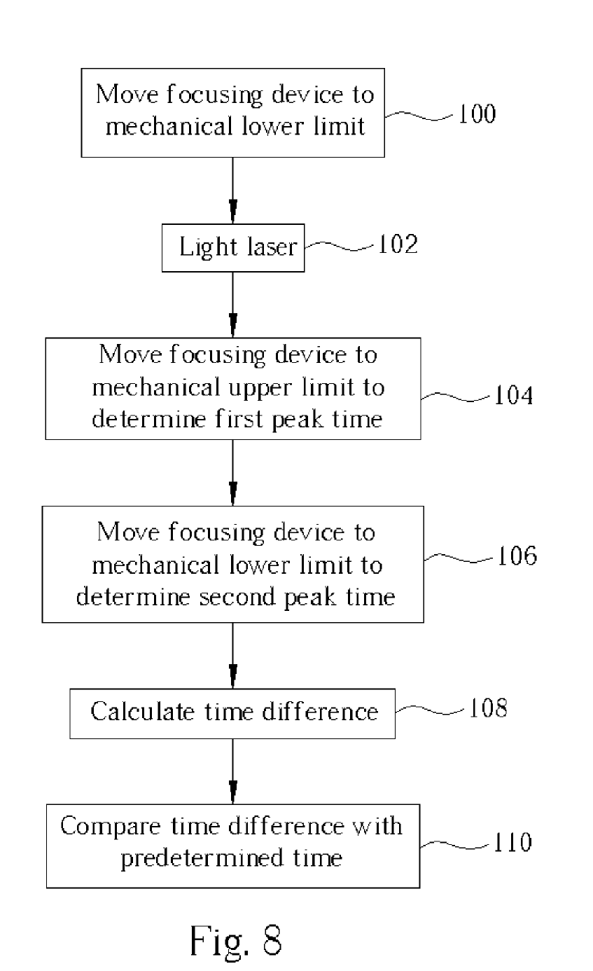

The present invention provides a method for discriminating optical media type, which can distinguish between DVDs and CDs. Referring to FIG. 1, FIG. 7 and FIG. 8, the procedure of the present invention is as follows:

S100 Move a focusing device of a pickup head to a mechanical lower limit;

S102 Light a laser;

S104 Move the focusing device of the pickup head to a mechanical upper limit, continue measuring the reflection of the laser beam when moving, and record a first peak time when the reflection is over a predetermined value of reflection (indicated by dotted lines);

S106 Move the focusing device of the pickup head to the mechanical lower limit, continue measuring the reflection of the laser beam when moving, and record a second peak time when the reflection is over a predetermined value of reflection;

S108 Calculate the time difference #t between the first peak time and the second peak time (#t=t2−t1 or #t=t4−t3);

S110 Compare the time difference #t and a predetermined time value in order to distinguish whether a disk is a DVD or a CD.

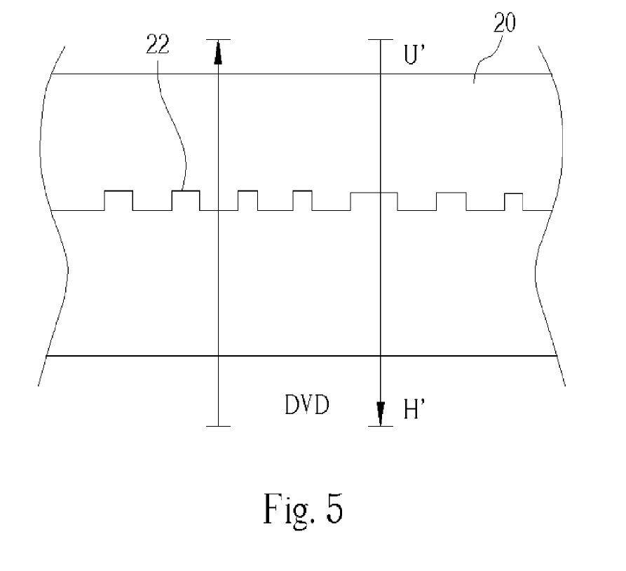

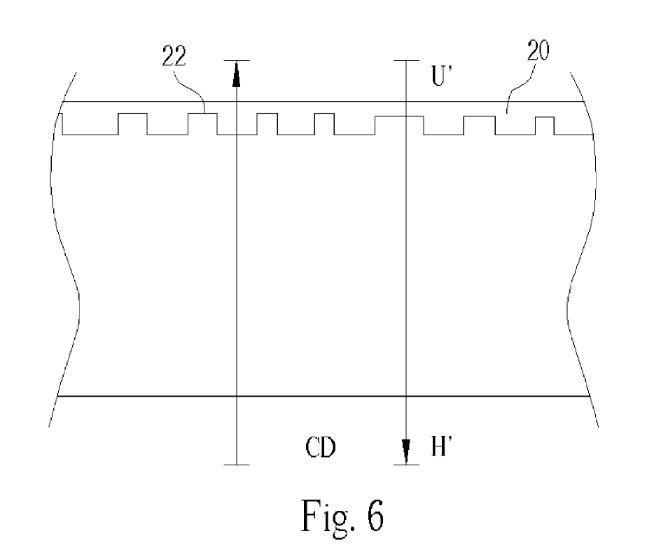

The method according to the present invention is as shown above. Firstly move the focusing device of the pickup head to a mechanical lower limit, then move the focusing device of the pickup head to a mechanical upper limit, and then move the focusing device of the pickup head back to the mechanical lower limit. As shown in FIG. 5 and FIG. 6, the light spot SP will move to a lower limit H″, then move to an upper limit U″, and then move back to the lower limit H″. In this process, the light spot SP will pass over the data layer 22 of a DVD (or the data layer 22 of a CD) twice. As shown in FIG. 7, because the light spot SP passes over the data layer 22 of the DVD earlier, the time difference #t=t2−t1 is larger, and because the data layer 22 of the CD is positioned in the inner part rather than that of the DVD, the light spot SP passes over the data layer 22 of the CD later, which causes a smaller time difference #t=t4−t3. As mentioned above, it is possible to distinguish the type of a disk by discriminating the time difference. If the time difference is larger than the predetermined value, the disk is a DVD, otherwise the disk is a CD.

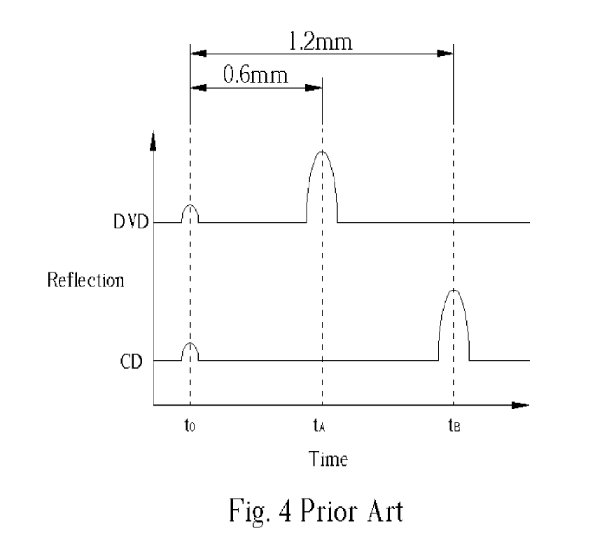

More specifically, in the present invention, in addition to moving the focusing device of the pickup head from the mechanical lower limit to the mechanical upper limit then back to the mechanical lower limit, the original position of the focusing device of the pickup head can be on the mechanical upper limit, and the process is proceeded in reverse to that shown in FIG. 4. Moreover, in the present invention, the path of the focusing device of the pickup head is not limited to simply traveling between the mechanical upper limit and the mechanical lower limit. Any path is acceptable, as long as the focusing device passes over the data layer 22 twice.

In addition, the type of the disk can be distinguished by calculating the total moving distance of the focusing device of the pickup head between two reflection peaks. If the focusing device of the pickup head moves from the mechanical lower limit to the mechanical upper limit then back to the mechanical lower limit, the total distance moved by the focusing device of the pickup head between two reflection peaks will be larger in the case of a DVD. Therefore, it is possible to first determine a predetermined distance used to compare with the total distance moved by the focusing device of the pickup head, in order to distinguish the type of the disk.

In contrast to the prior art, the method for discriminating optical media type according to the present invention provides a rapid and efficient solution to distinguish between DVDs and CDs. Additionally, the disadvantage of the prior art, the difficulty of detecting the transparent layer“s boundary, is resolved.

Those skilled in the art will readily observe that numerous modifications and alterations of the method, such as measuring magnetic change or phase change instead of measuring reflection as mentioned above, may be made while retaining the teachings of the invention. Accordingly, the above disclosure should be construed as limited only by the metes and bounds of the appended claims

What is claimed is:

1. A method for discriminating optical media type for an optical drive to discriminate the type of optical media rapidly, the optical drive comprising a reading unit capable of converging a laser beam to a light spot, the method comprising:
(a) positioning a reading unit of the optical drive at a first position;
(b) moving the reading unit to a second position so that the light spot passes over a data layer of the optical media;
(c) continuing recording the reflection of the laser beam to obtain a first time when the reflection is larger than a predetermined reflection;
(d) moving the reading unit back to the first position so that the light spot passes over the data layer of the optical media;
(e) continuing recording the reflection of the laser beam to obtain a second time when the reflection is larger than a predetermined reflection; and
(f) calculating a time difference between the second time and the first time and comparing the time difference with at least one predetermined time in order to discriminate the type of the optical media.

2. The method of claim 1 wherein the optical media is an optical disk, and the optical drive is an optical disk drive.

3. The method of claim 2 wherein the reading unit is a pickup head.

4. The method of claim 3 wherein the first position is a mechanical upper limit, the second position is a mechanical lower limit, and the moving direction in step (b) is away from the disk.

5. The method of claim 3 wherein the first position is a mechanical lower limit, the second position is a mechanical upper limit, and the moving direction in the step (b) is toward to the disk.

6. The method of claim 2 wherein the disk type can be distinguished by comparing the time difference between the second time and the first time with a predetermined time.

7. A method for discriminating optical media type used in an optical drive, the optical drive comprising a pickup head movable between a first position and a second position, the method comprising:
(a) moving the pickup head from the first position to the second position then back to the first position, and calculating the total time the pickup head spends between two reflection peaks; and
(b) comparing the total time with a predetermined time in order to discriminate the type of the optical media.

8. The method of claim 7 wherein the two reflection peaks occur when a laser beam generated by the pickup head twice passes over a data layer of the optical media.

9. A method for discriminating optical media used in an optical drive, the optical drive comprising a pickup head movable between a first position and a second position, the method comprising:
(a) moving the pickup head from the first position to the second position then back to the first position, and calculating the total distance the pickup head moves between two reflection peaks; and
(b) comparing the total distance with a predetermined distance in order to discriminate the type of the optical media.

10. The method of claim 9 wherein the two reflection peaks occur when a laser beam generated by the pickup head twice passes over a data layer of the optical media.
